(19) United States
(12) Patent Application Publication
(10) Pub. No.: US 2019/0354553 A1
(43) Pub. Date: Nov. 21, 2019

(54) COMPUTER SYSTEM, SERVER DEVICE, AND PROGRAM FOR UTILIZING CLUSTER OF ATTRIBUTE INFORMATION OF INDIVIDUAL

(71) Applicant: alt Inc., Tokyo (JP)

(72) Inventors: Takashi Eguchi, Tokyo (JP); Kazutaka Yonekura, Tokyo (JP)

(21) Appl. No.: 16/477,151

(22) PCT Filed: Nov. 9, 2017
(86) PCT No.: PCT/JP2017/040397

§ 371 Date: Jul. 10, 2019

(30) Foreign Application Priority Data
Jan. 10, 2017 (JP) 2017-001740

(51) Int. Cl. G06F 16/906; G06F 16/9032; G06F 16/903; G06F 17/27

(52) U.S. Cl. CPC G06F 16/906; G06F 17/277; G06F 16/90344; G06F 16/90332

(57) ABSTRACT

A computer system for utilizing a cluster of attribute information of an individual comprises means for storing a cluster of attribute information of an individual, wherein the attribute information of the individual is expressed by a set of (S, P, O), S indicates a subject, P indicates an attribute, and O indicates a value of the attribute, and means for utilizing the cluster of attribute information of the individual. In embodiment, the attribute of the individual comprises an individual property of the individual or memory of the individual. In one embodiment, the attribute of the individual is dependent on a subjective view of the individual.

### TECHNICAL FIELD

The present invention relates to a computer system, a server device, and a program for utilizing a cluster of attribute information of an individual.

### BACKGROUND ART

A technology for extracting and storing the relationship between two items has been known. Patent Literature 1 discloses a system for extracting a corresponding relationship between a product name and product classification from inputted text data. The corresponding relationship extracted by the system of Patent Literature 1 is a universal corresponding relationship. The specific product name can be found from a product classification with such a system.

FIG. 8 shows a conventional interactive device 11 answering a question from a user. The interactive device 11 is connected to a database unit 12. The user can communicate with the interactive device 11 by using a user device 13 (e.g., personal computer, tablet, smartphone, or the like) that is connected to the interactive device 11. The interactive device 11 receives a question from the user via the user device 13 and answers the question. The interactive device 11 searches in the database unit 12 to obtain information that is suitable for an answer to the question. For example, if a user asks “what is the height of Mount Fuji?”, the interactive device 11 searches in the database unit 12 to obtain information related to the height of Mount Fuji, and answers “3776 meters”. For example, if a user asks “what is the weather like today?”, the interactive device 11 searches in the database unit 12 to obtain information related to today's weather and answers “Sunny, with a high of 25° C.”. Questions that can be answered by the interactive device 11 are limited to universal questions for which the answer is the same for everyone, such as the aforementioned “what is the height of Mount Fuji?” and “what is the weather like today?”. This is because the database unit 12 for searching an answer stores universal subject matters in an encyclopedic manner.

### CITATION LIST

### Patent Literature

### [PTL 1] Japanese Laid-Open Publication No. 2011-103038

### SUMMARY OF INVENTION

### Technical Problem

The objective of the invention is to provide a computer system, a server device, and a program for utilizing a cluster of attribute information of an individual.

### Solution to Problem

The computer system for utilizing a cluster of attribute information of an individual of the invention comprises means for storing a cluster of attribute information of an individual, wherein the attribute information of the individual is expressed by a set of (S, P, O), S indicates a subject, P indicates an attribute, and O indicates a value of the attribute, and means for utilizing the cluster of attribute information of the individual.

In one embodiment of the invention, the attribute of the individual comprises an individual property of the individual or memory of the individual.

In one embodiment of the invention, the attribute of the individual is dependent on a subjective view of the individual.

In one embodiment of the invention, the computer system further comprises means for receiving a question, wherein the means for utilizing the cluster of attribute information of the individual comprises means for searching the cluster of attribute information of the individual based on the question, means for generating an answer to the question based on a result of the search, and means for outputting the answer.

In one embodiment of the invention, the means for searching comprises: means for extracting S and P from the question, means for identifying a set of (S, P, O) comprising S and P matching the S and P extracted from the question by searching the cluster of attribute information of the individual; and means for identifying O in the identified set of (S, P, O) as a result of the search.

In one embodiment of the invention, the means for searching is configured to perform: extracting S and P from the question; determining a number of S's n (n≥2) into which the S extracted from the question is to be divided; dividing the S extracted from the question into n S's, wherein the S is divided into first S, . . . nth S; identifying a set of (S, P, O) comprising S and P matching S=first S and P=second S by searching the cluster of attribute information of the individual and identifying O in the identified set of (S, P, O) as first O; repeating

(1) identifying a set of (S, P, O) comprising S and P matching S=ith O and P=i+2th S by searching the cluster of attribute information of the individual and identifying O in the identified set of (S, P, O) as i+1th O, and (2) incrementing i so that i=i+1
from i=1 to i=n; and identifying a set of (S, P, O) comprising S and P matching S=nth O and P=P extracted from the question by searching the cluster of attribute information of the individual and identifying O in the identified set of (S, P, O) as a result of the search.

In one embodiment of the invention, the computer system further comprises: means for receiving natural language data; and means for extracting attribute information of an individual from the natural language data, the attribute information of an individual being expressed by a set of (S, P, O); wherein the means for storing the cluster of attribute information of the individual is configured to accumulate attribute information of an individual expressed by a set of (S, P, O) by storing the extracted attribute information of the individual.

The computer system for utilizing a cluster of attribute information of an individual of the invention comprises: at least one user device; and a server device configured to be able to connect to the at least one user device via a network; wherein the server device is connected to a database unit, a cluster of attribute information of an individual is stored in the database unit, the attribute information of the individual is expressed by a set of (S, P, O), S indicates a subject, P indicates an attribute, and O indicates a value of the attribute, wherein each of the at least one user devices is configured to be able to transmit a request to the server device via the network, and wherein the server device is configured to perform at least: receiving the request via the network; and executing processing to utilize the cluster of attribute information of the individual stored in the database unit in response to the request.

The server device used in the computer system for utilizing a cluster of attribute information of an individual of the invention is configured to be able to connect to at least one user device via a network, wherein the server device is connected to a database unit, a cluster of attribute information of an individual is stored in the database unit, the attribute information of the individual is expressed by a set of (S, P, O), S indicates a subject, P indicates an attribute, and O indicates a value of the attribute, wherein the server device comprises a processor unit, and wherein the processor unit is configured to perform at least: receiving a request via the network from one of the at least one user device; and executing processing to utilize the cluster of attribute information of the individual stored in the database unit in response to the request.

In one embodiment of the invention, a program executed in a server device used in a computer system for utilizing a cluster of attribute information of an individual is provided, the server device being configured to be able to connect to at least one user device via a network, wherein the server device is connected to a database unit, a cluster of attribute information of an individual is stored in the database unit, the attribute information of the individual is expressed by a set of (S, P, O), S indicates a subject, P indicates an attribute, and O indicates a value of the attribute, wherein the server device comprises a processor unit, and wherein the program, when executed by the processor unit, causes the processor unit to perform processing comprising: receiving a request via the network from one of the at least one user device; and executing processing to utilize the cluster of attribute information of the individual stored in the database unit in response to the request.

### Advantageous Effects of Invention

The present invention can provide a computer system, a server device, and a program for utilizing a cluster of attribute information of an individual.

### BRIEF DESCRIPTION OF DRAWINGS

FIG. 1A is a diagram showing user A making a personal AI 100 learn an attribute of individual X.

FIG. 1B is a diagram showing the personal AI 100 materializing a “digital clone” of individual X answering questions from multiple users.

FIG. 1C is a diagram showing the personal AI 100 materializing a “digital clone” of individual Y, who is different from individual X, answering questions from multiple users.

FIG. 2 is a diagram depicting an example of a configuration of a computer system 200 for materializing the personal AI 100.

FIG. 3 is a diagram depicting an example of a data configuration of a cluster of attribute information of an individual stored in a database unit 220.

FIG. 4 is a block diagram depicting an example of a configuration of a server device 210.

FIG. 5 is a flowchart depicting an example of processing for storing a cluster of attribute information of an individual by the computer system 200.

FIG. 6 is a flow chart depicting an example of processing by the computer system 200 answering a question of a user by utilizing a cluster of attribute information of an individual when the cluster of attribute information of an individual is utilized in personal AI.

FIG. 7 is a flow chart depicting an example of the search methodology in step S604.

FIG. 8 is a diagram showing a conventional interactive device 11 answering questions from a user.

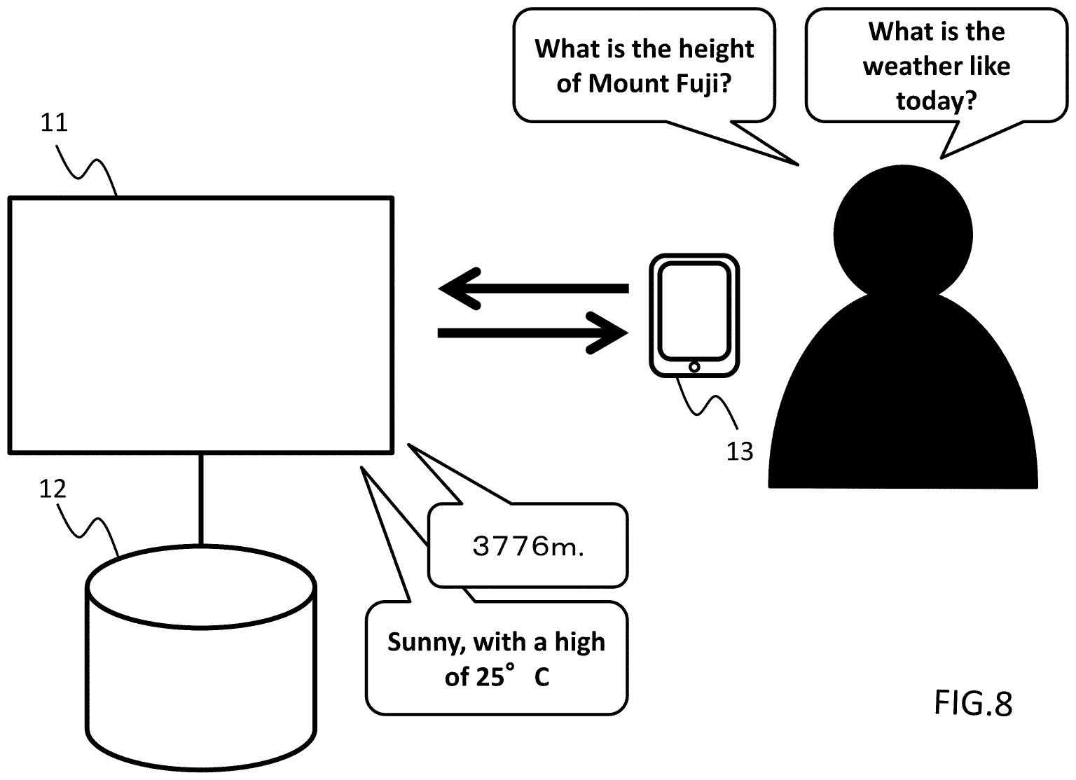

### DESCRIPTION OF EMBODIMENTS

The embodiments of the invention are explained hereinafter with reference to the drawings.

1. Personal AI Materializing “Digital Clone” of a Human

The inventors of the invention have developed personal artificial intelligence (personal AI). Personal AI learns information of a person, e.g., action or thought of the person, to act like the person. As a result, a “digital clone” of the person can be materialized by the personal AI. A “digital clone” can answer a question or perform a task in place of the person.

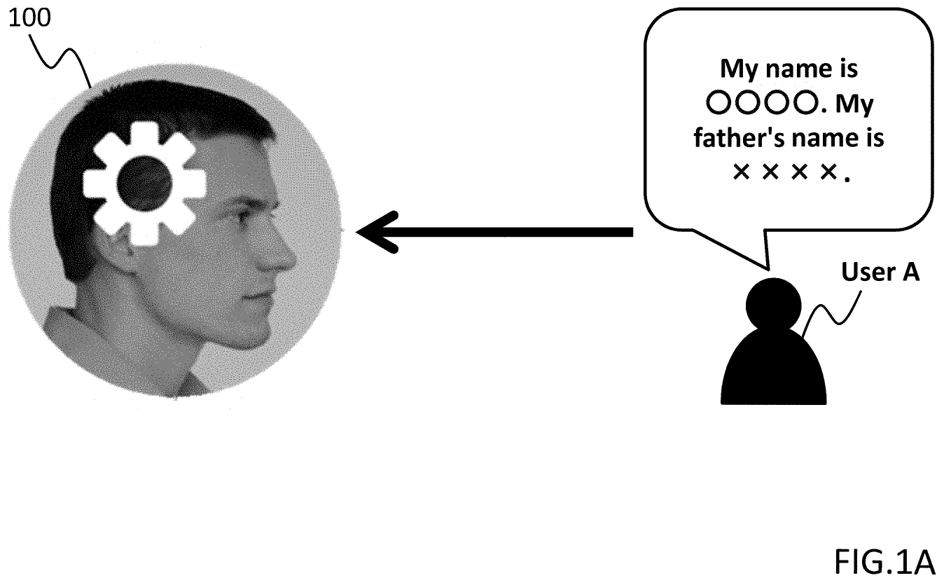

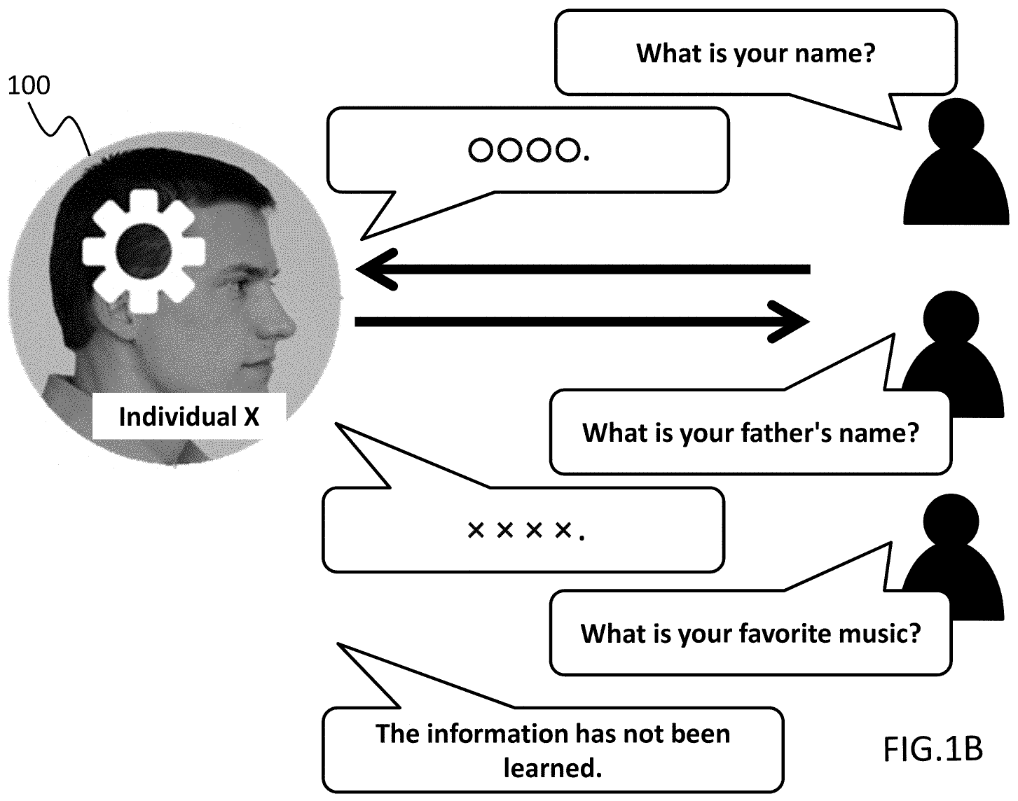

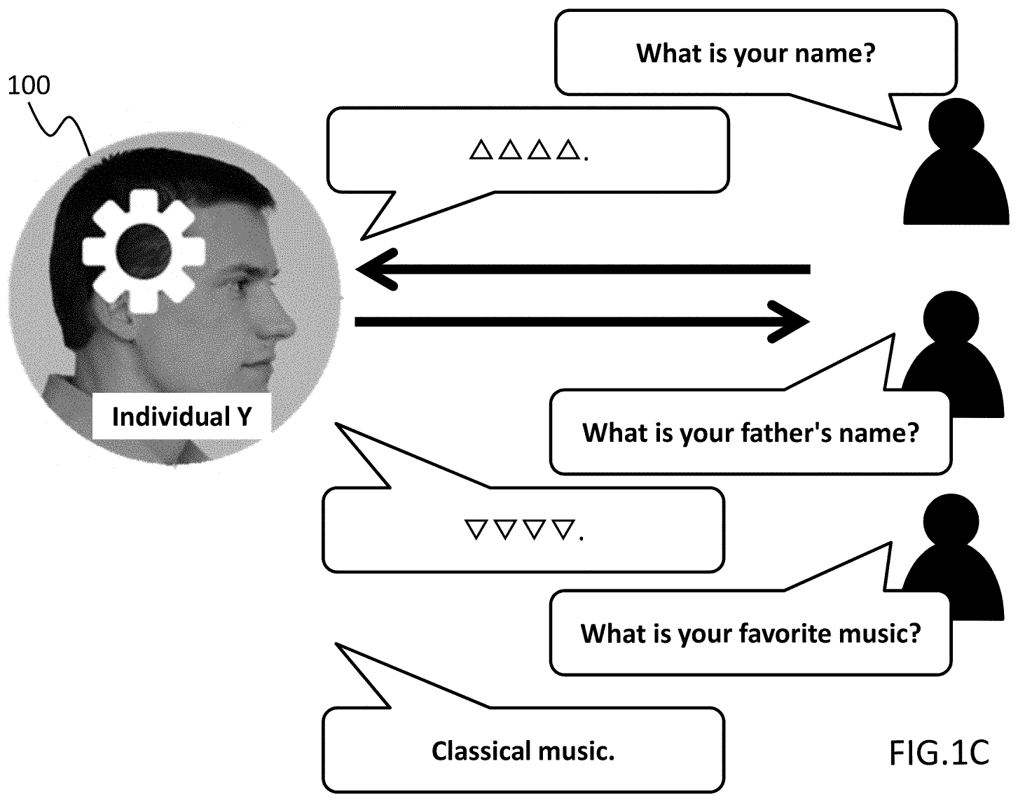

FIG. 1A shows user A making a personal AI 100 learn an attribute of individual X.

The user A inputs “My name is ∘∘∘∘. My father's name is xxxx” to make the personal AI 100 learn an attribute of individual X. The user A can input any other information to make the personal AI 100 learn an attribute of individual X. The user A can input, for example, the place of birth of individual X, hobby of individual X, occupation of individual X, or the like into the personal AI 100. In this regard, the method of input can be any method. For example, text can be inputted into the personal AI 100, or an input other than text (e.g., speech) can be inputted into the personal AI 100 by the user. When a user inputs an input other than text into the personal AI 100, the personal AI 100 can be configured to convert an input other than text into text. This enables the personal AI 100 to perform processing for a user input that is an input other than text, which is the same processing for a user input that is a text input.

The personal AI 100 learns an attribute of individual X. Specifically, the personal AI 100 extracts information related to an attribute of individual X from an input by the user A and systematically stores the information to learn the attribute of individual X. The personal AI 100 which has learned an attribute of individual X can materialize a “digital clone” of individual X that can answer a question related to the attribute of individual X.

While the user A inputted an attribute of individual X to make the personal AI 100 learn in order to materialize a “digital clone” of individual X by the personal AI 100, the user A can also materialize a “digital clone” of the user A by inputting his/her own attribute.

FIG. 1B shows the personal AI 100 materializing a “digital clone” of individual X answering questions from multiple users.

The personal AI 100 can answer questions from multiple users based on an attribute of individual X that has been already learned. For example, the personal AI 100 answers “∘∘∘∘” to the question “what is your name?” from a user because the personal AI 100 has already learned that individual X's name is ∘∘∘∘. For example, the personal AI 100 answers “xxxx” to the question “What is your father's name?” from a user because the personal AI 100 has already learned that the name of individual X's father is xxxx. For example, the personal AI 100 answers “The information has not been learned” to the question “What is your favorite music?” from a user because the personal AI 100 has not learned individual X's favorite music. The personal AI 100 answers a question related to an attribute of individual X in place of individual X.

FIG. 1C shows the personal AI 100 materializing a “digital clone” of individual Y, who is different from individual X, answering questions from multiple users.

The personal AI 100 gives an answer that is different from an answer given by the personal AI 100 materializing a “digital clone” of individual X. This is because individual X and individual Y have different attributes, so that information that is inputted to make the personal AI learn individual properties of individual X and information that is inputted to make the personal AI learn individual properties of individual Y by the user A are different, resulting in information learned by the personal AI 100 being different. For example, if the user A has inputted “My name is ΔΔΔΔ. My father's name is ∇∇∇∇. My favorite music is classical music” so that the personal AI 100 has learned such information as attributes of individual Y, the personal AI 100 answers “ΔΔΔΔ” to the question “What is your name?” from a user because the personal AI 100 has already learned that the name of individual Y is ΔΔΔΔ. The personal AI 100 answers “∇∇∇∇” to the question “What is your father's name?” from a user because the personal AI 100 has already learned that the name of individual Y's father is ∇∇∇∇. The personal AI 100 answers “classical music” to the question “What is your favorite music?” from a user because the personal AI 100 has already learned that individual Y's favorite music is classical music. In this manner, the personal AI 100 can not only give different answers to the same question depending the individual whose digital clone is materialized, but also give an answer that is specialized for the individual. A user asking a question can obtain an answer to a question from personal AI of a desirable person by asking a question after selecting in advance whose answer the questioning user would like to hear.

2. Configuration of Computer System 200 for Materializing Personal AI 100

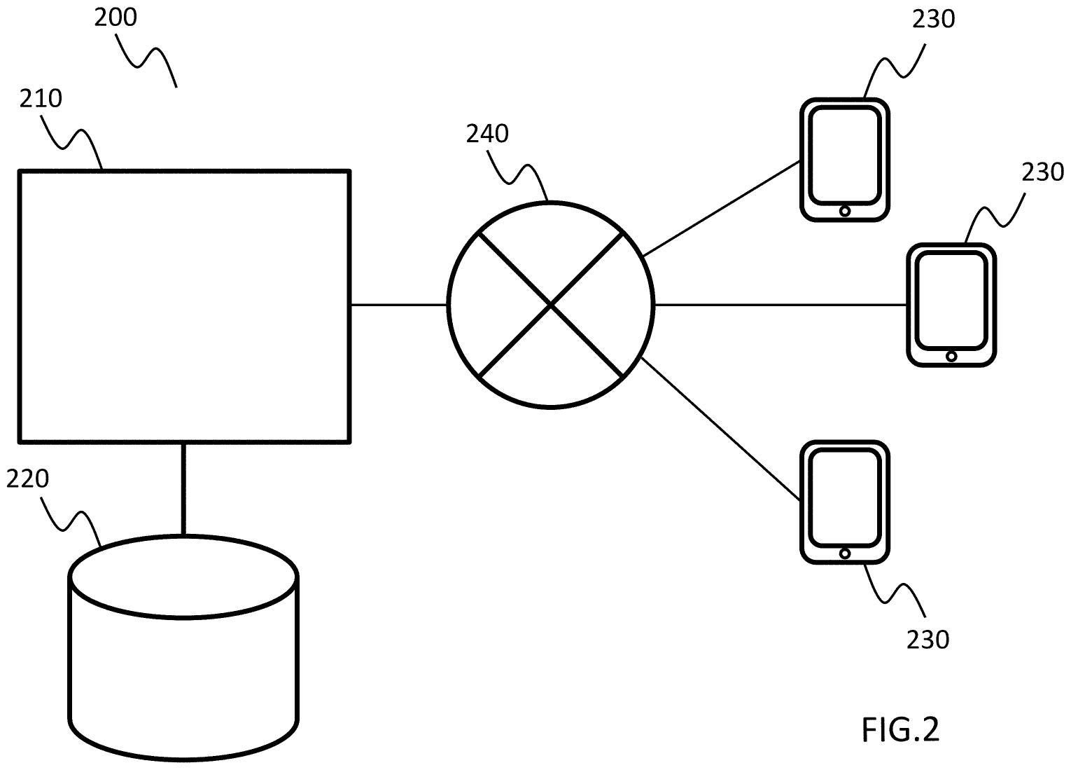

FIG. 2 depicts an example of a configuration of a computer system 200 for materializing the personal AI 100.

The computer system 200 comprises a server device 210, a database unit 220 connected to the server device 210, and a user device 230 connected to the server device 210 via a network 240. The user device 230 can be any terminal device such as a personal computer, tablet, or smartphone. The user device 230 can communicate with the server device 210 via the network 240. In this regard, the network 240 can be any type of network. For example, the user device 230 can communicate with the server device 210 via the Internet, or communicate with the server device 210 via LAN.

The database unit 220 stores a cluster of attribute information of an individual. Attribute information of an individual is expressed by a set of (S, P, O). In this regard, S is an element indicating a subject (Subject), P is an element indicating an attribute (Predicate), and O is an element indicating a value of the attribute (Object).

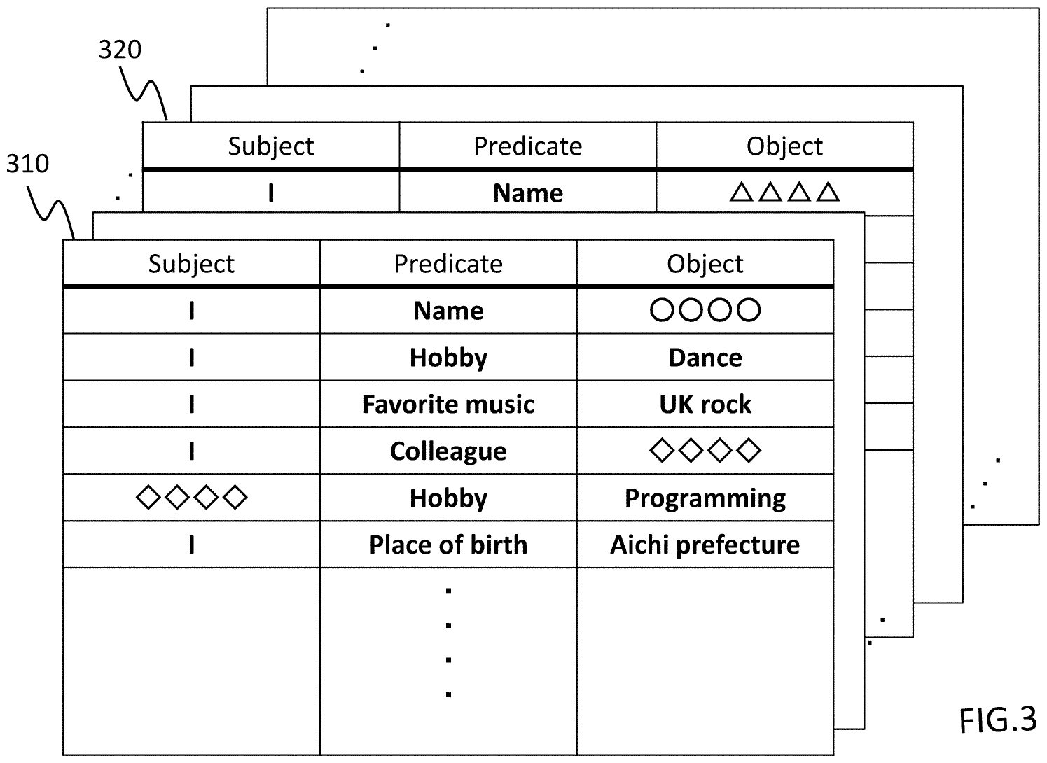

FIG. 3 depicts an example of a data configuration of a cluster of attribute information of an individual stored in the database unit 220.

The database unit 220 stores attribute information of an individual, with S (Subject), P (Predicate), and O (Object) as a set. The database unit 220 comprises a database for storing attribute information of individuals by each individual. For example, the database unit 220 comprises a database 310 for storing attribute information of individual X and a database 320 for storing attribute information of individual Y. For example, the database 310 stores a set of (S=I, P=name, O=◯◯◯◯), a set of (S=I, P=hobby, O=dance), a set of (S=I, P=favorite music, O=UK rock), a set of (S=I, P=colleague, O=◯◯◯◯), and the like as attribute information of individual X. For example, the database 320 stores a set of (S=I, P=name, O=ΔΔΔΔ) and the like as attribute information of individual Y.

For example, attribute information of an individual stored in the database unit 220 can express an individual property of an individual by a set of S, P, O. The set of S, P, O expressing an individual property of an individual is, for example, a set of (S=I, P=hobby, O=dance), a set of (S=⋄⋄⋄⋄, P=special talent, O=programming), or the like. A set of S, P, O expressing an individual property of an individual can be any other set.

For example, attribute information of an individual stored in the database unit 220 can express memory of the individual by a set of S, P, O. A set of S, P, O expressing memory of the individual can be, for example, a set of “S=I, P=place of birth, O=Aichi prefecture), (S=I, P=dream, O=programmer), a set of (S=I, P=previous job, O=musician), or the like. A set of S, P, O expressing memory of an individual can be any other set.

For example, attribute information of an individual stored in the database unit 220 can express a subjective attribute of the individual by a set of S, P, O. A subjective attribute of an individual is an attribute dependent on the subjectivity of the individual. For example, a set of S, P, O expressing a subjective attribute of an individual is a set (S=steel, P=color, O=brown) when the color of steel for individual X is brown, a set (S=steel, P=color, O=silver) when the color of steel for individual Y is silver, a set (S=apple, P=color, O=red) when the color of apple for individual X is red, a set (S=apple, P=color, O=green) when the color of apple for individual Y is green, or the like. A set of S, P, O expressing a subjective attribute of an individual can be any other set.

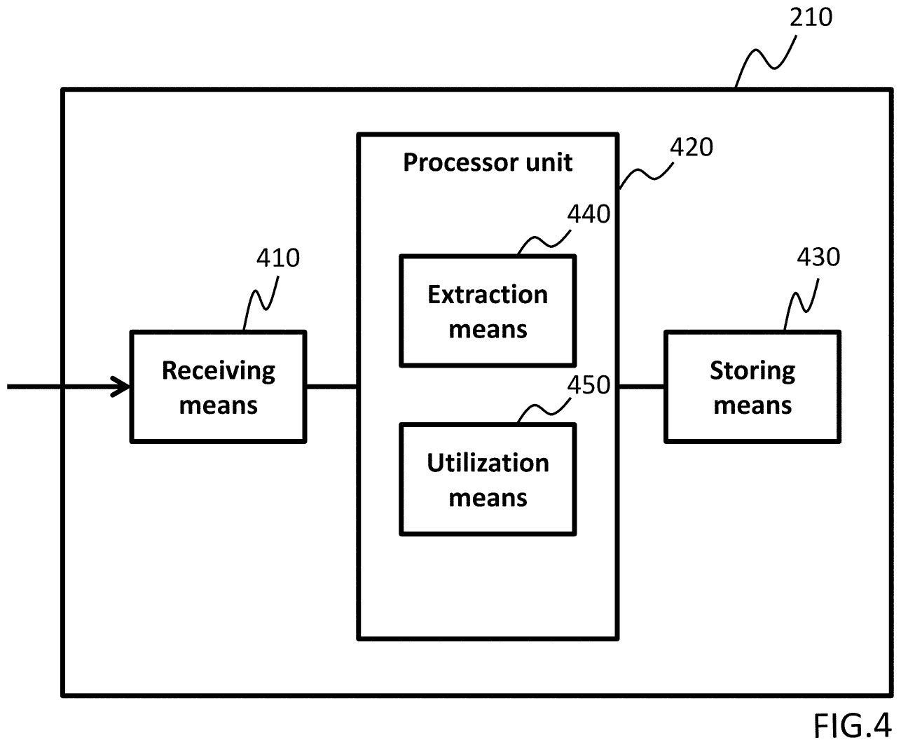

FIG. 4 depicts an example of a configuration of the server device 210.

The server device 210 comprises receiving means 410, a processor unit 420, and storing means 430. The processor unit 420 comprises extraction means 440 and utilization means 450.

The receiving means 410 receives any data from the outside of the server device 210. The receiving means 410 can receive natural language data from the outside of the server device 210. The data received by the receiving means 410 can be of any form. For example, the receiving means 410 can receive data in a text format, or data can be received as speech. The receiving means 410 can receive data in any manner. For example, the receiving means 410 can receive data from manual input by a user or receive data via a network or the like. When the receiving means 410 receives data via a network or the like, the network can be any type of network. For example, the receiving means 410 can receive data via the Internet or via LAN. For example, the receiving means 410 can receive data that is read out from a storage medium that stores data.

The processor unit 420 executes processing of the server device 210 and controls the overall operation of the server device 210. The processor unit 420 reads out a program stored in the storing means 430 and executes the program. This allows the server device 210 to function as a device that executes a desired step. The processor unit 420 can be implemented by a single processor or multiple processors.

The storing means 430 stores a program required for executing processing of the server device 210, data required for executing the program, or the like. The storing means 430 can store a program causing the processor unit 420 to execute processing for utilizing a cluster of attribute information of an individual. The storing means 430 can be implemented by any storing means.

The extraction means 440 within the processor unit 420 executes processing for extracting attribute information of an individual from natural language data received by the receiving means 410. The attribute information of an individual can be extracted by the extraction means 440 in any manner. The extraction means 440 can extract attribute information of an individual using, for example, a rule-based extraction methodology for extracting corresponding data using regular expression or the like. The extraction means 440 can also extract attribute information of an individual using, for example, a grammar based extraction methodology. The extraction means 440 can also extract attribute information of an individual using a data driven methodology for obtaining information such as “Taro=person's name” using a technology of named entity extraction or the like to extract information using such information as a hint. The extraction means 440 can also extract attribute information of an individual by machine learning using, for example, deep learning or the like using a sentence including past extracted data or the like as training data. The extraction means 440 can extract attribute information of an individual by combining, for example, a rule-based extraction methodology, grammar based extraction methodology, data driven methodology, and machine learning. Attribute information of an individual extracted by the extraction means 440 is stored in the database unit 220 that is connected to the server device 210.

The utilization means 450 within the processor unit 420 executes processing for utilizing a cluster of attribute information of an individual stored in the database unit 220 for any application. The utilization means 450 can execute processing for utilizing a cluster of attribute information of an individual in response to a request by a user received from the outside of the server device 210. For example, the utilization means 450 can utilize a cluster of attribute information of an individual for the personal AI 100 described above. In this regard, the utilization means 450 obtains information that is suitable for an answer to a question by a user that has been inputted to the computer system 200 by searching a cluster of attribute information of an individual stored in the database unit 220 in response to the question. The unitization means 450 can utilize a cluster of attribute information of an individual in order to generate, for example, a lifelog (action history information). For example, a lifelog for tracking a change in attributes of an individual over time can be created by storing attributes that can change over time such as “current address” or “hobby”, including the temporal information thereof, in the database unit 220. In this regard, the utilization means 450 obtains information that is suitable for creating a lifelog by searching a cluster of attribute information of an individual stored in the database unit 220 in response to receiving a request to create a lifelog from a user.

In the example depicted in FIG. 4, each constituent element of the server device 210 is provided within the server device 210, but the present invention is not limited thereto. A system with one of the constituent elements of the server device 210 provided externally to the server device 210 can also be constructed. For example, the receiving means 410, the processor unit 420, and the storing means 430 can be comprised of separate hardware parts from one another, and each hardware part can be connected via any network. For example, the extraction means 440 and the utilization means 450 can be external to the processor unit 420, the receiving means 410, the processor unit 420, the storing means 430, the extraction means 440, and the utilization means 450 can be comprised of separate hardware parts from one another, and each hardware part can be connected via any network. In this regard, the network can be any type of network. Each hardware part can be connected via the Internet, LAN, wireless connection, or wired connection.

In the example depicted in FIG. 4, the database unit 220 is provided external to the server device 210, but the present invention is not limited thereto. The database unit 220 can also be provided internal to the server device 210. In this regard, the database unit 220 can be implemented by the same or different storing means as the storing means 430. The configuration of the database unit 220 is not limited to a specific hardware configuration. For example, the database unit 220 can be comprised of a single hardware part or multiple hardware parts. For example, the database unit 220 can be configured as an external hard disk drive of the server device 210 or as cloud storage connected via a network.

The example described above has explained that the database unit 220 stores a cluster of attribute information of an individual, but the information stored by the database unit 220 is not limited to a cluster of attribute information of an individual. The database unit 220 can store any other information. For example, the database unit 220 can store universal corresponding relationship between two items in an encyclopedic manner in the same manner as a conventional database unit 20.

The example described above has explained that a user communicates with the server device 210 via the network 240 using the user device 230, but a user can interact with the computer system 200 in any manner. A user can indirectly interact with the computer system 200 using the user device 230 connected to the network 240, or directly interact with the computer system 200 without going through the network 240.

The server device 210 is connected to the external database unit 220 external to the server device 210 in the example described above, but the present invention is not limited thereto. The database unit 220 can be outside or inside the server device 210. If outside the server device 210, the server device 210 and the database unit 220 can be connected in any manner, e.g., connection via the Internet, a local area network, wireless connection, or wired connection.

The computer system 200 described above can utilize a cluster of attribute information of an individual stored in the database unit 220 in any application in response to a user request inputted into the user device 230. The personal AI 100 explained with reference to FIGS. 1A to 1C is one utilization example of a cluster of attribute information of an individual.

3. Processing for Learning Attribute of Individual by Computer System 200

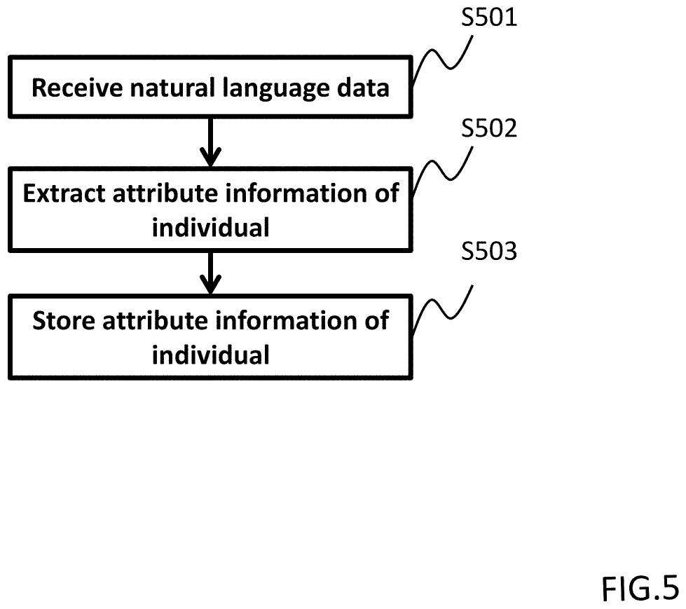

As a premise for the computer system 200 to utilize a cluster of attribute information of an individual, the computer system 200 needs to learn an attribute of an individual in advance. FIG. 5 depicts an example of processing for learning an attribute of an individual by the computer system 200.

In step S501, the receiving means 410 of the server device 210 of the computer system 200 receives natural language data. The receiving means 410 receives natural language data that has been inputted into the user device 230 of the computer system 200 by a user.

In step S502, the extraction means 440 within the processor unit 420 of the server device 210 extracts attribute information of an individual from natural language data. The extraction means 440 extracts attribute information of an individual by any extraction methodology from the natural language data received by the receiving means 410. For example, the extraction means 440 can extract attribute information of an individual by combining a rule based extraction methodology, grammar based extraction methodology, data driven methodology, and machine learning.

For example, a set of S, P, O, i.e., (S=I, P=name, O=◯◯◯◯), is extracted from the received natural language data of “My name is ooo”. For example, a set of (S=I, P=hobby, O=dance) is extracted from the received natural language data of “My hobby is dance”. For example, sets of (S=I, P=colleague, O=◯◯◯◯) and (S=⋄⋄⋄⋄, P=special talent, O=programming) are extracted from the received natural language data, “The special talent of my colleague ⋄⋄⋄⋄ is programming”.

In step S503, the server device 210 stores attribute information of an individual in the database unit 220. The server device 210 stores attribute information of an individual expressed by a set of (S, P, O), which represents an attribute of an individual extracted by the extraction means 440, in the database unit 220.

The computer system 200 stores multiple attribute information of individual representing attributes of the individual into the database unit 220 and accumulates attribute information of individual expressed by sets of (S, P, O) in the database unit 220 by repeating the processing of S501 to S503. The database unit 220 stores a cluster of attribute information of individual thereby. In this manner, the computer system 200 learns an attribute of an individual.

4. Processing for Utilizing a Cluster of Attribute Information of an Individual by Computer System 200

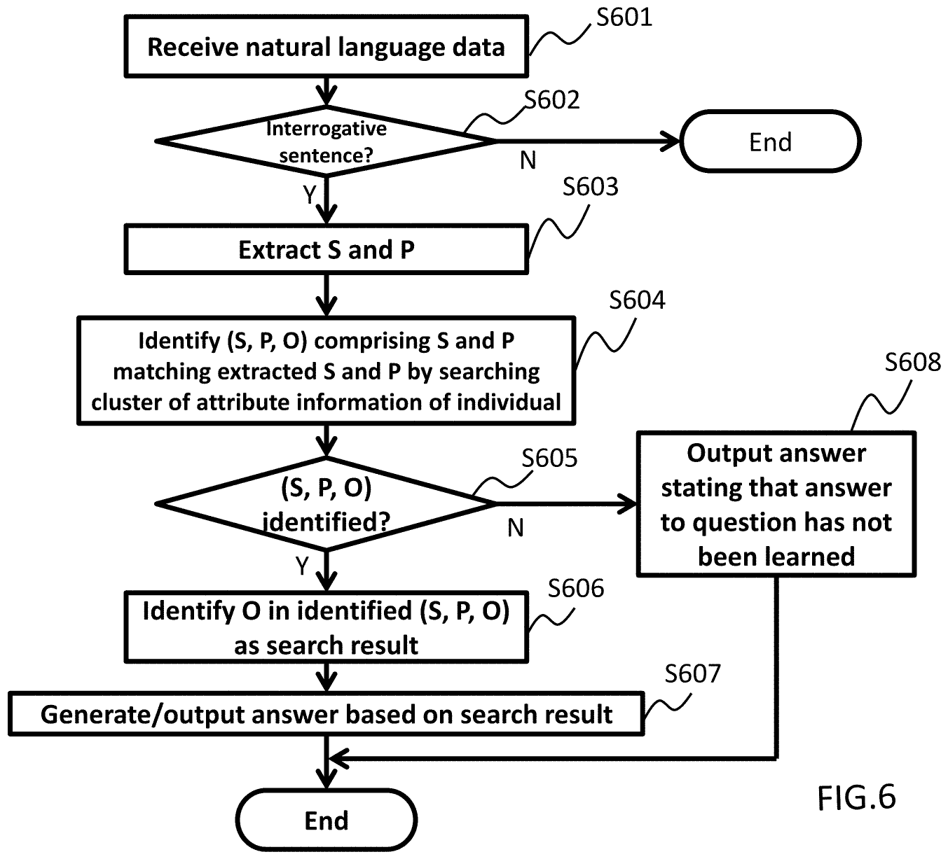

FIG. 6 depicts an example of processing for answering a user question as an exemplary embodiment of the computer system 200 utilizing a cluster of attribute information of an individual. The computer system 200 is assumed to have already stored a cluster of attribute information of an individual in the database unit 220.

In step S601, the receiving means 410 of the server device 210 first receives natural language data. The receiving means 410 receives natural language data that has been inputted into the user device 230 of the computer system 200.

In step S602, the processor unit 420 of the server device 210 determines whether the received natural language data is an interrogative sentence. The methodology to determine whether data is an interrogative sentence can be any methodology. For example, it can be determined that data is an interrogative sentence by extracting an interrogative word within the natural language data. For example, if natural language data is received as speech, the data can be determined as an interrogative sentence by the intonation at the end of the sentence. If it is determined that the data is an interrogative sentence in step S602, the process proceeds to step S603. If the data is determined not to be an interrogative sentence in step 3602, the processing to answer a user question ends.

In step S603, the extraction means 440 within the processor unit 420 of the server device 210 extracts S and P among attribute information of an individual from the received natural language data. The extraction means 440 can extract S and P by any extraction methodology.

In step S604, the utilization means 450 within the processor unit 420 of the server device 210 identifies (S, P, O) comprising S and P matching the extracted S and P by searching a cluster of attribute information of an individual stored in the database unit 220. A cluster of attribute information of an individual stored in the database unit 220 can be searched using any methodology. In this regard, the utilization means 450 can apply a conditional equation such as “if S extracted in step 3603 is (S=you), it shall be (S=I)” prior to the search. This enables a suitable search even if different terms refer to the same subject (e.g., first person, second person, etc.)

In step 3605, it is determined whether the utilization means 450 within the processor unit 420 of the server device 210 has identified (S, P, O) comprising S and P matching the extracted S and P. If it is determined that the utilization means 450 has identified (S, P, O), the process proceeds to step S606. If it is determined that the utilization means 450 was not able to identify (S, P, O), the process proceeds to step S608.

In step S606, the utilization means 450 within the processor unit 420 of the server device 210 identifies O in the identified (S, P, O) as a search result.

In step S607, the utilization means 450 within the processor unit 420 of the server device 210 generates an answer to a question based on the search result and outputs the answer. For example, the utilization means 450 generates and outputs an answer to a question such as “xxxx”, based on (O=xxxx) in the identified (S, P, O). The method of outputting with the utilization method 450 can be any method. For example, the utilization means 450 can output O by speech or text.

In step S608, the utilization means 450 within the processor unit 420 of the server device 210 outputs that the answer to the question has not been learned. This is because a suitable answer to a question from a user could not be identified. The method of outputting by the utilization method 450 can be any method. For example, the utilization means 450 can output a response by speech or text.

After outputting an answer to a question or outputting that the answer to the question has not been learned, processing to answer a user question ends.

In this regard, processing by the computer system 200 when the personal AI 100 materializing a digital clone of individual X provides an answer to the question “What is your name?” by user Z is explained as an example. It is assumed that a set of S, P, O of (S=I, P=name, O=∘∘∘∘) representing the attribute “name” of individual X is already stored in the database unit 220.

In step S601, the receiving means 410 of the server device 210 first receives natural language data “What is your name?” that has been inputted into the user device 230 by the user Z.

In step S602, the processor unit 420 of the server device 210 determines whether the received natural language data “What is your name?” is an interrogative sentence. In this regard, the natural language data “What is your name?” is an interrogative sentence, so that the process proceeds to step S603.

In step S603, the extraction means 440 within the processor unit 420 of the server device 210 extracts S and P among attribute information of an individual from the received natural language data “What is your name?”. In this regard, a set of S and P of (S=you, P=name) is extracted.

In step S604, the utilization means 450 within the processor unit 420 of the server device 210 identifies (S, P, O) comprising S and P matching the extracted S and P by searching a cluster of attribute information of an individual stored in the database unit 220. The utilization means 450 searches after applying the conditional equation “If S extracted in step S603 is (S=you), it shall be (S=I)” and converting (S=you) to (S=I). Since a set of S, P, O of (S=I, P=name, O=∘∘∘∘) is stored in the database unit 220, the utilization means 450 can identify (S=I, P=name, P=∘∘∘∘) comprising (S=I, P=name) by any searching methodology.

In step S605, the utilization means 450 within the processor unit 420 of the server device 210 determines whether (S, P, O) comprising the extracted S and P has been identified. Since the utilization means 450 has identified (S=I, P=name, O=∘∘∘∘) comprising (S=I, P=name), the process proceeds to step S606.

In step S606, the utilization means 450 within the processor unit 420 of the server device 210 identifies (O=∘∘∘∘) in the identified (S=I, P=name, O=∘∘∘∘) as a search result.

In step S607, the utilization means 450 within the processor unit 420 of the server device 210 generates and outputs an answer to the question “∘∘∘∘” based on the search result. The process then ends.

With such processing by the computer system 200, the personal AI 100 materializing a digital clone of individual X can provide an answer of “∘∘∘∘” to the question “What is your name?”.

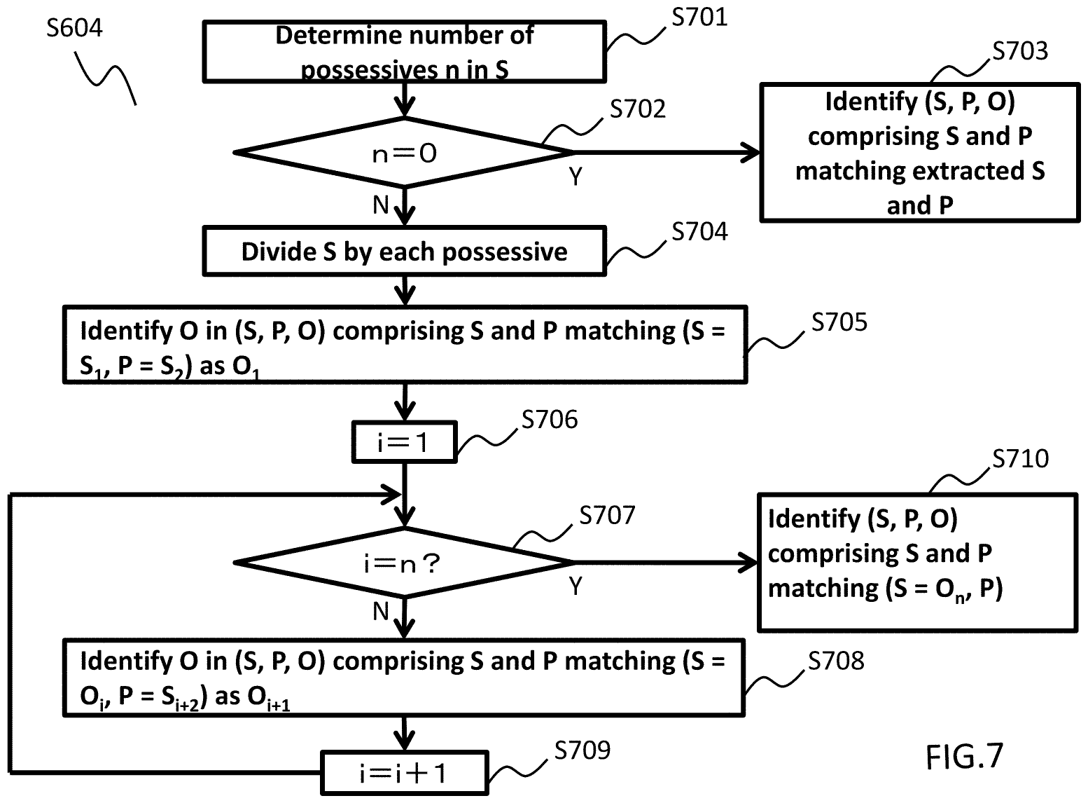

FIG. 7 depicts an example of a searching methodology in step S604. Such a searching methodology can be used when searching a cluster of attribute information of an individual stored in the database unit 220 in order to identify (S, P, O) comprising (S, P) when the extracted S contains a possessive.

In step S701, the utilization means 450 determines the number of possessives n in S. For example, the number of possessives n of “S=you” extracted from the question “What is your name?” is n=0. For example, the number of possessives n of (S=brother of mother of you) extracted from the question “What is the hobby of the brother of your mother?” is n=2.

In step S702, the utilization means 450 determines whether n=0. If n=0, the process proceeds to step S703. If not n=0, the process proceeds to step S704.

In step S703, S does not have a possessive, so that the utilization means 450 identifies (S, P, O) comprising the extracted (S, P) by simply searching a cluster of attribute information of an individual stored in the database unit 220.

In step S704, the utilization means 450 divides S for each possessive, such that S is expressed as (S=Sₙ₊₁ of . . . of S₂ of S₁). For example, the aforementioned (S=brother of mother of you) would be (S₁=you, S₂=mother, S₃=brother).

In step S705, the utilization means 450 identifies O in (S, P, O) comprising S, P matching (S=S₁, P=S₂) as O₂ by searching a cluster of attribute information of an individual stored in the database unit 220. For example, if a set of S, P, O of (S=I, P=mother, O=Hanako) is stored in the database unit 220 when (S=brother of mother of you) as described above, the utilization means 450 first applies the condition equation of “if S extracted in step S603 is (S=you), it shall be (S=I)” to convert (S=you) to (S=I) and then searches a cluster of attribute information of an individual stored in the database unit 220 to identify (O=Hanako) in (S=I, P=mother, O=Hanako) comprising (S=I, P=mother) as O₁, such that (O₁=Hanako).

In step S706, variable i is defined as i=1.

In step S707, the utilization means 450 determines whether i=n. If not i=n, the process proceeds to step S708.

In step S708, the utilization means 450 identifies O in (S, P, O) comprising S and P matching (S=Oᵢ, P=Sᵢ₊₂) as Oᵢ₊₁ by searching a cluster of attribute information of an individual stored in the database unit 220. For example, if a set of S, P, O of (S=Hanako, P=brother, O=Taro) is stored in the database unit 220 when (S=brother of mother of you) as described above, the utilization means 450 identifies (O=Taro) in (S=Hanako, P=brother, O=Taro) comprising (S=O₁=Hanako, P=S₃=brother) as O₂ by searching a cluster of attribute information of an individual stored in the database unit 220, such that (O₂=Taro).

In step S709, variant i is incremented. S707 to S709 are repeated until i=n. If it is determined that i=n in step S707, the process proceeds to step S710.

In step S710, the utilization means 450 identifies (S, P, O) comprising S and P matching (S=Oₙ, P) by searching a cluster of attribute information of an individual stored in the database unit 220. For example, if a set of S, P, O of (S=Taro, P=hobby, O=programming) is stored in the database unit 220 when (S=brother of mother of you) as described above, the utilization means 450 identifies (S=Taro, P=hobby, O=programming) comprising (S=O₂=Taro, P=hobby) by searching a cluster of attribute information of an individual stored in the database unit 220.

In this manner, a suitable search can be performed to generate an answer to a question even if S extracted from the question contains a possessive.

The processing described above is one example, so that the utilization means 450 can process using any other algorithm. The example described above determined the number of possessives n contained in S and divided S for each possessive, but the utilization means 450 can divide S using any other criteria.

While the example described above has explained an example of the computer system 200 utilizing a cluster of attribute information of an individual for the personal AI 100, the computer system 200 can utilize a cluster of attribute information of an individual in any other application. For example, the computer system 200 can utilize a cluster of attribute information of an individual in fields such as speech recognition, input prediction, search engines, bots, Email autoreply, chat autoreply, CS support, or expert system.

The present invention is not limited to the aforementioned embodiments. It is understood that the scope of the present invention should be interpreted solely by the scope of the claims. It is understood that those skilled in the art can implement an equivalent scope, based on the descriptions of the invention and common general knowledge, from the descriptions of the specific preferred embodiments of the invention.

### INDUSTRIAL APPLICABILITY

The present invention has utility as an invention providing a computer system, a server device, and a program for utilizing a cluster of attribute information of an individual.

### REFERENCE SIGNS LIST

100 Personal AI
200 Computer system
210 Server device
220 Database unit
230 User device
240 Network

1. A computer system for utilizing a cluster of attribute information of an individual, the computer system comprising:
means for storing a cluster of attribute information of an individual, wherein the attribute information of the individual is expressed by a set of (S, P, O), S indicates a subject, P indicates an attribute, and O indicates a value of the attribute;
means for utilizing the cluster of attribute information of the individual; and
means for receiving a question,
wherein the means for utilizing the cluster of attribute information of the individual comprise:
means for searching the cluster of attribute information of the individual based on the question;
means for generating an answer to the question based on a result of the search; and
means for outputting the answer,
wherein the means for searching is configured to perform:
extracting S and P from the question;
determining a number of S's n (n≥2) into which the S extracted from the question is to be divided;
dividing the S extracted from the question into n S's, wherein the S is divided into first S, . . . nth S;
identifying a set of (S, P, O) comprising S and P matching S=first S and P=second S by searching the cluster of attribute information of the individual and identifying O in the identified set of (S, P, O) as first O;
repeating:
(1) identifying a set of (S, P, O) comprising S and P matching S=ith O and P=i+2th S by searching the cluster of attribute information of the individual and identifying O in the identified set of (S, P, O) as i+1th O, and
(2) incrementing i so that i=i+1
from i=1 to i=n−1; and
identifying a set of (S, P, O) comprising S and P matching S=nth O and P=P extracted from the question by searching the cluster of attribute information of the individual and identifying O in the identified set of (S, P, O) as a result of the search.

2. The computer system of claim 1, wherein the attribute of the individual comprises an individual property of the individual or memory of the individual.

3. The computer system of claim 1, wherein the attribute of the individual is dependent on a subjective view of the individual.

4-6. (canceled)

7. The computer system of claim 1, wherein the computer system further comprises:
means for receiving natural language data; and
means for extracting attribute information of an individual from the natural language data, the attribute information of an individual being expressed by a set of (S, P, O);
wherein the means for storing the cluster of attribute information of the individual is configured to accumulate attribute information of an individual expressed by a set of (S, P, O) by storing the extracted attribute information of the individual.

8. A computer system for utilizing a cluster of attribute information of an individual, the computer system comprising:
at least one user device; and
a server device configured to be able to connect to the at least one user device via a network;
wherein the server device is connected to a database unit, a cluster of attribute information of an individual is stored in the database unit, the attribute information of the individual is expressed by a set of (S, P, O), S indicates a subject, P indicates an attribute, and O indicates a value of the attribute,
wherein each of the at least one user devices is configured to be able to transmit a question to the server device via the network, and
wherein the server device is configured to perform at least:
receiving the question via the network; and
executing processing to utilize the cluster of attribute information of the individual stored in the database unit in response to the question,
wherein the processing to utilize comprises:
searching the cluster of attribute information of the individual based on the question;
generating an answer to the question based on a result of the search; and
outputting the answer,
wherein the searching comprises:
extracting S and P from the question;
determining a number of S's n (n≥2) into which the S extracted from the question is to be divided;
dividing the S extracted from the question into n S's, wherein the S is divided into first S, . . . nth S;
identifying a set of (S, P, O) comprising S and P matching S=first S and P=second S by searching the cluster of attribute information of the individual and identifying O in the identified set of (S, P, O) as first O;
repeating:
(1) identifying a set of (S, P, O) comprising S and P matching S=ith O and P=i+2th S by searching the cluster of attribute information of the individual and identifying O in the identified set of (S, P, O) as i+1th O, and
(2) incrementing i so that i=i+1
from i=1 to i=n−1; and
identifying a set of (S, P, O) comprising S and P matching S=nth O and P=P extracted from the question by searching the cluster of attribute information of the individual and identifying O in the identified set of (S, P, O) as a result of the search.

9. A server device used in a computer system for utilizing a cluster of attribute information of an individual, the server device being configured to be able to connect to at least one user device via a network,
wherein the server device is connected to a database unit, a cluster of attribute information of an individual is stored in the database unit, the attribute information of the individual is expressed by a set of (S, P, O), S indicates a subject, P indicates an attribute, and O indicates a value of the attribute,
wherein the server device comprises a processor unit, and
wherein the processor unit is configured to perform at least:
receiving a question via the network from one of the at least one user device; and
executing processing to utilize the cluster of attribute information of the individual stored in the database unit in response to the question,
wherein the processing to utilize comprises:
searching the cluster of attribute information of the individual based on the question;
generating an answer to the question based on a result of the search; and
outputting the answer,
wherein the searching comprises:
extracting S and P from the question;
determining a number of S's n (n≥2) into which the S extracted from the question is to be divided;
dividing the S extracted from the question into n S's, wherein the S is divided into first S, . . . nth S;
identifying a set of (S, P, O) comprising S and P matching S=first S and P=second S by searching the cluster of attribute information of the individual and identifying O in the identified set of (S, P, O) as first O;
repeating:
(1) identifying a set of (S, P, O) comprising S and P matching S=ith O and P=i+2th S by searching the cluster of attribute information of the individual and identifying O in the identified set of (S, P, O) as i+1th O, and
(2) incrementing i so that i=i+1
from i=1 to i=n−1; and
identifying a set of (S, P, O) comprising S and P matching S=nth O and P=P extracted from the question by searching the cluster of attribute information of the individual and identifying O in the identified set of (S, P, O) as a result of the search.

10. A program executed in a server device used in a computer system for utilizing a cluster of attribute information of an individual, the server device being configured to be able to connect to at least one user device via a network,
wherein the server device is connected to a database unit, a cluster of attribute information of an individual is stored in the database unit, the attribute information of the individual is expressed by a set of (S, P, O), S indicates a subject, P indicates an attribute, and O indicates a value of the attribute,
wherein the server device comprises a processor unit, and
wherein the program, when executed by the processor unit, causes the processor unit to perform processing comprising:
receiving a question via the network from one of the at least one user device; and
executing processing to utilize the cluster of attribute information of the individual stored in the database unit in response to the question,
wherein the processing to utilize comprises:
searching the cluster of attribute information of the individual based on the question;
generating an answer to the question based on a result of the search; and
outputting the answer,
wherein the searching comprises:
extracting S and P from the question;
determining a number of S's n (n≥2) into which the S extracted from the question is to be divided:
dividing the S extracted from the question into n S's, wherein the S is divided into first S, . . . nth S;
identifying a set of (S, P, O) comprising S and P matching S=first S and P=second S by searching the cluster of attribute information of the individual and identifying O in the identified set of (S, P, O) as first O;
repeating:
(1) identifying a set of (S, P, O) comprising S and P matching S=ith O and P=i+2th S by searching the cluster of attribute information of the individual and identifying O in the identified set of (S, P, O) as i+1th O, and
(2) incrementing i so that i=i+1
from i=1 to i=n−1; and
identifying a set of (S, P, O) comprising S and P matching S=nth O and P=P extracted from the question by searching the cluster of attribute information of the individual and identifying O in the identified set of (S, P, O) as a result of the search.

11. The computer system of claim 2, wherein the attribute of the individual is dependent on a subjective view of the individual.

12. The computer system of claim 2, wherein the computer system further comprises:
means for receiving natural language data; and
means for extracting attribute information of an individual from the natural language data, the attribute information of an individual being expressed by a set of (S, P, O);
wherein the means for storing the cluster of attribute information of the individual is configured to accumulate attribute information of an individual expressed by a set of (S, P, O) by storing the extracted attribute information of the individual.

13. The computer system of claim 3, wherein the computer system further comprises:
means for receiving natural language data; and
means for extracting attribute information of an individual from the natural language data, the attribute information of an individual being expressed by a set of (S, P, O);
wherein the means for storing the cluster of attribute information of the individual is configured to accumulate attribute information of an individual expressed by a set of (S, P, O) by storing the extracted attribute information of the individual.

14. The computer system of claim 11, wherein the computer system further comprises:
means for receiving natural language data; and
means for extracting attribute information of an individual from the natural language data, the attribute information of an individual being expressed by a set of (S, P, O);
wherein the means for storing the cluster of attribute information of the individual is configured to accumulate attribute information of an individual expressed by a set of (S, P, O) by storing the extracted attribute information of the individual.
